(19) United States
(12) Patent Application Publication
(10) Pub. No.: US 2009/0318021 A1
(43) Pub. Date: Dec. 24, 2009

(54) ULTRAMINIATURE COAX CONNECTOR

(75) Inventors: Robert Neil Mulfinger, York Haven, PA (US); John Joseph Consoli, Harrisburg, PA (US); Edmund Luther Jacobs, Harrisburg, PA (US); Richard Allen Burgit, Middletown, PA (US); David Keay Fowler, Boiling Springs, PA (US); Kenneth William Ellis, Etters, PA (US); Alan Anthony Kordas, Lewisberry, PA (US); Troy Conner, York, PA (US); Alice M. Conner, York, PA (US)

Correspondence Address: ROBERT J. KAPALKA;TYCO TECHNOLOGY RESOURCES, 4550 NEW LINDEN HILL ROAD, SUITE 140, WILMINGTON, DE, 19808, US

(73) Assignee: TYCO ELECTRONICS CORPORATION, Berwyn, PA (US)

(21) Appl. No.: 12/145,097

(22) Filed: Jun. 24, 2008

(51) Int. Cl. H01R 9/05

(52) U.S. Cl. 439/582; 439/578

(57) ABSTRACT

An ultraminiature coax connector (UMCC) is provided for terminating a coaxial cable. The UMCC includes an electrically conductive housing extending between a cable-receiving end portion and a mating end portion. The cable-receiving end portion being is configured to engage an insulating cover of the coaxial cable. The mating end portion is configured to engage another UMCC. The housing includes an outer electrical contact at the mating end portion. The outer electrical contact includes an outer diameter in the range of approximately one millimeter to approximately four millimeters or an inner diameter in the range of approximately one millimeter to approximately four millimeters. An insulating member is by the housing. An inner electrical contact is held by the insulating member. The inner electrical contact includes a plug contact portion that is configured to be received by a receptacle contact portion of the other UMCC.

### BACKGROUND OF THE INVENTION

The subject matter described and/or illustrated herein relates generally to electrical connectors for coaxial cables, and more particularly, to ultraminiature coax connectors (UMCCs).

Due to their favorable electrical characteristics, coaxial cables and connectors have grown in popularity for interconnecting electronic devices and peripheral systems. Coaxial cable connectors typically include an inner electrical contact coaxially disposed within an outer electrical contact of an electrically conductive housing, with a dielectric material separating the inner electrical contact and the electrically conductive housing. The inner electrical contact terminates the end of an inner electrical conductor of the coaxial cable, while the electrically conductive housing terminates an outer electrical conductor of the coaxial cable that is coaxial with the inner electrical conductor. The outer electrical conductor of the coaxial cable and the electrically conductive housing of the coaxial cable connector typically serve as the ground path.

One known standard of coaxial connectors is typically referred to as an ultraminiature coax connector (UMCC). The outer electrical contact of UMCCs either functions as a receptacle or a plug, which typically includes respective inner and outer diameters of approximately two millimeters. Specifically, with regard to two UMCCs that are configured to be mated together, a first of the UMCCs includes an outer electrical contact that typically has an outer diameter of approximately two millimeters and the second of the UMCCs includes an outer electrical contact that typically has an inner diameter of approximately two millimeters such that the outer electrical contact of the first UMCC is configured to be received within the outer electrical contact of the second UMCC. With the ongoing trend toward smaller, faster, and higher performance electrical components, the use of UMCCs has grown. However, cable-terminated UMCCs having outer electrical contacts that function as receptacles are not currently available.

### BRIEF DESCRIPTION OF THE INVENTION

In one embodiment, an ultraminiature coax connector (UMCC) is provided for terminating a coaxial cable. The UMCC includes an electrically conductive housing extending between a cable-receiving end portion and a mating end portion. The cable-receiving end portion being is configured to engage an insulating cover of the coaxial cable. The mating end portion is configured to engage another UMCC. The housing includes an outer electrical contact at the mating end portion. The outer electrical contact includes an outer diameter in the range of approximately one millimeter to approximately four millimeters or an inner diameter in the range of approximately one millimeter to approximately four millimeters. An insulating member is by the housing. An inner electrical contact is held by the insulating member. The inner electrical contact includes a plug contact portion that is configured to be received by a receptacle contact portion of the other UMCC.

In another embodiment, an ultraminiature coax connector (UMCC) assembly is provided. The UMCC assembly includes a first UMCC terminating a first coaxial cable. The first UMCC includes a first electrically conductive housing including a first outer electrical contact. The first outer electrical contact includes a first outer diameter in the range of approximately one millimeter to approximately four millimeters or a first inner diameter in the range of approximately one millimeter to approximately four millimeters. A first insulating member is held by the first housing. A first inner electrical contact is held by the first insulating member. The UMCC assembly also includes a second UMCC terminating a second coaxial cable. The second UMCC includes a second electrically conductive housing including a second outer electrical contact engaged with the first outer electrical contact of the first UMCC. The second outer electrical contact includes a second outer diameter in the range of approximately one millimeter to approximately four millimeters or a second inner diameter in the range of approximately one millimeter to approximately four millimeters. A second insulating member is held by the second housing. A second inner electrical contact is held by the second insulating member and engaged with the first inner electrical contact of the first UMCC.

In another embodiment, an ultraminiature coax connector (UMCC) assembly is provided. The UMCC assembly includes a first UMCC configured to terminate a first coaxial cable. The first UMCC includes a first electrically conductive housing including a first outer electrical contact. The first outer electrical contact includes a first outer diameter in the range of approximately one millimeter to approximately four millimeters or a first inner diameter in the range of approximately one millimeter to approximately four millimeters. The UMCC assembly also includes a second UMCC configured to terminate a second coaxial cable. The second UMCC includes a second electrically conductive housing comprising a second outer electrical contact. The second outer electrical contact includes a second outer diameter in the range of approximately one millimeter to approximately four millimeters or a second inner diameter in the range of approximately one millimeter to approximately four millimeters. The first and second UMCCs are configured to be mated together to interconnect the first and second coaxial cables.

### BRIEF DESCRIPTION OF THE DRAWINGS

FIG. 1 is a perspective view of an exemplary embodiment of ultraminiature coax connector (UMCC) illustrating the UMCC terminating the end of a coaxial cable.

FIG. 2 is another perspective view of the UMCC and coaxial cable shown in FIG. 1.

FIG. 3 is a cross-sectional view of the UMCC and coaxial cable shown in FIGS. 1 and 2 taken along line 3-3 of FIG. 1.

FIG. 4 is a perspective view of another exemplary embodiment of a UMCC illustrating the UMCC terminating the end of another coaxial cable.

FIG. 5 is a cross-sectional view of the UMCC and coaxial cable shown in FIG. 4 taken along line 5-5 of FIG. 4.

FIG. 6 is a perspective view of an exemplary embodiment of a UMCC assembly illustrating the UMCC shown in FIGS. 1-3 mated together with the UMCC shown in FIGS. 4 and 5.

FIG. 7 is a partially broken-away perspective view illustrating a cross section of the UMCC assembly shown in FIG. 6 taken along line 7-7 of FIG. 6.

### DETAILED DESCRIPTION OF THE INVENTION

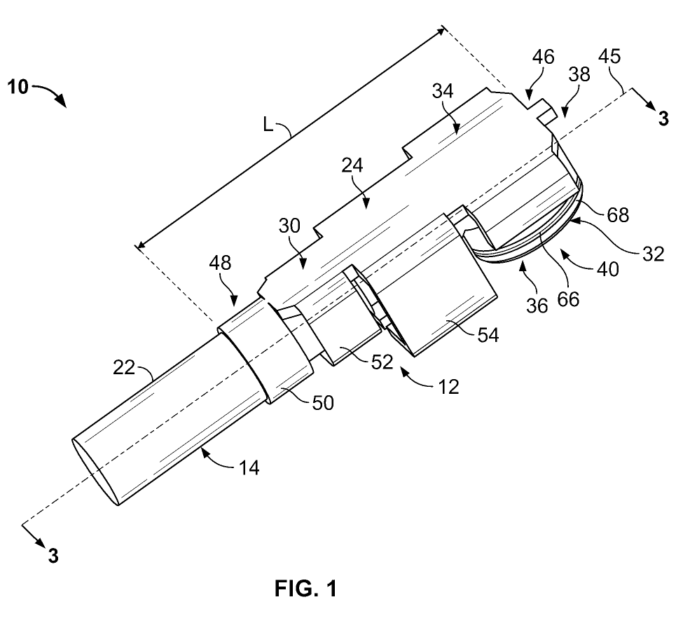

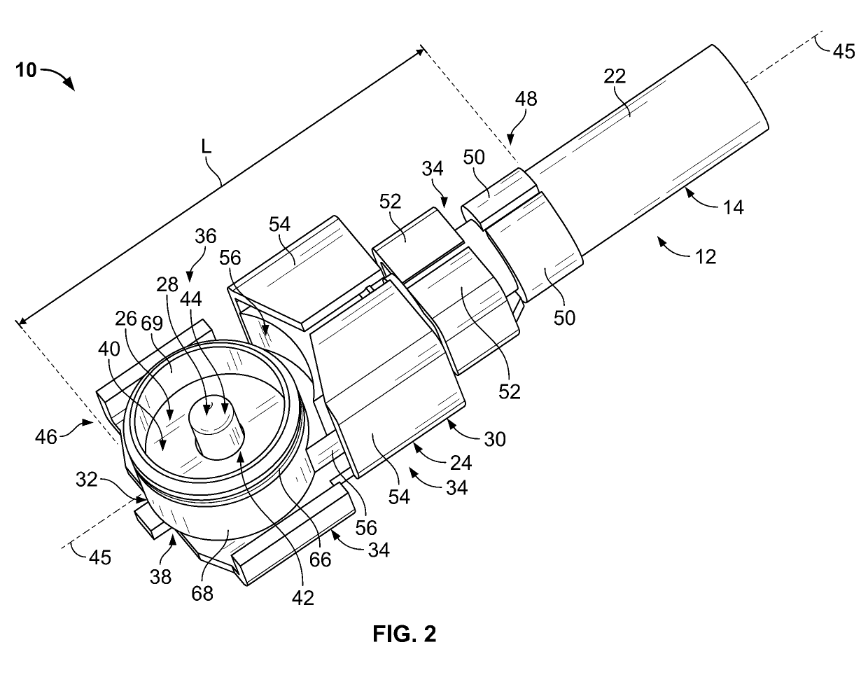

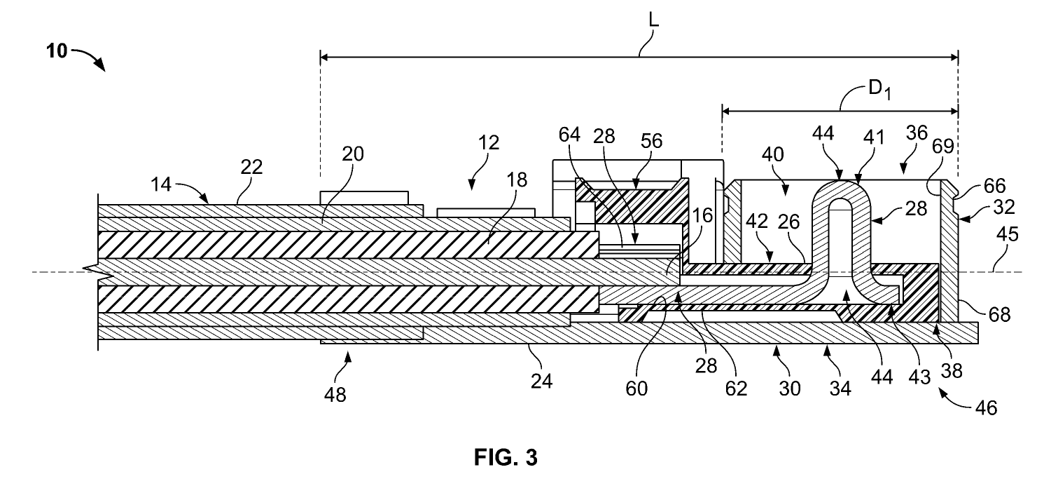

FIGS. 1 and 2 are perspective views of an exemplary embodiment of an ultraminiature coax connector (UMCC) 10 illustrating the UMCC 10 terminating the end 12 of a coaxial cable 14. FIG. 3 is a cross-sectional view of the UMCC 10 and coaxial cable 14 taken along line 3-3 of FIG. 1. As can be seen in FIG. 3, the coaxial cable 14 includes an inner electrical conductor 16, an insulating member 18 surrounding the inner electrical conductor 16, an outer electrical conductor 20 surrounding the insulating member 18, and an insulating cover 22 surrounding the outer electrical conductor 20. The inner electrical conductor 16, the insulating member 18, the outer electrical conductor 20, and the insulating cover 22 are coaxial, with the insulating member 18 positioned radially outward from the inner electrical conductor 16, the outer electrical conductor 20 positioned radially outward from the insulating member 18, and the insulating cover 22 positioned radially outward from the outer electrical conductor 20. In the exemplary embodiment, the inner electrical conductor 16 is a signal path while the outer electrical conductor 20 is a ground path. However, alternatively the inner electrical conductor 16 may be a ground path while the outer electrical conductor 20 is a signal path.

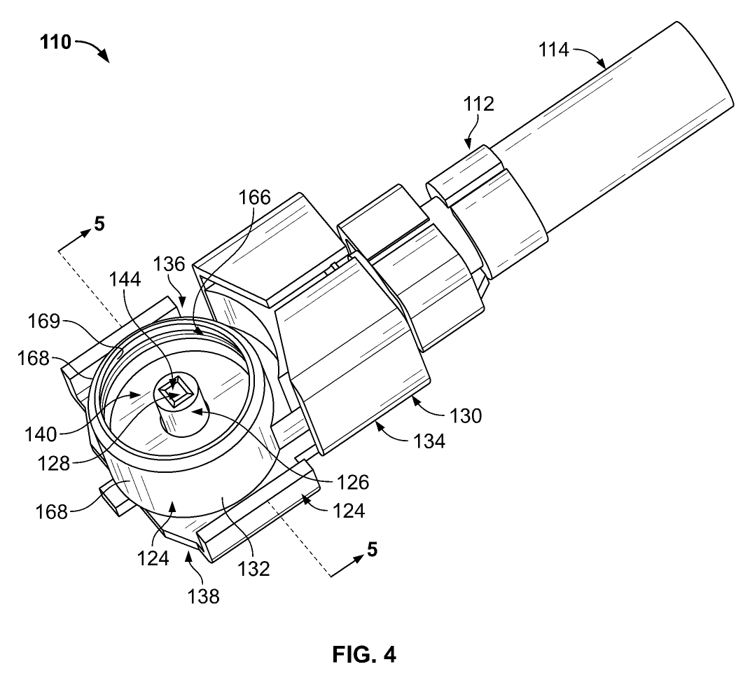

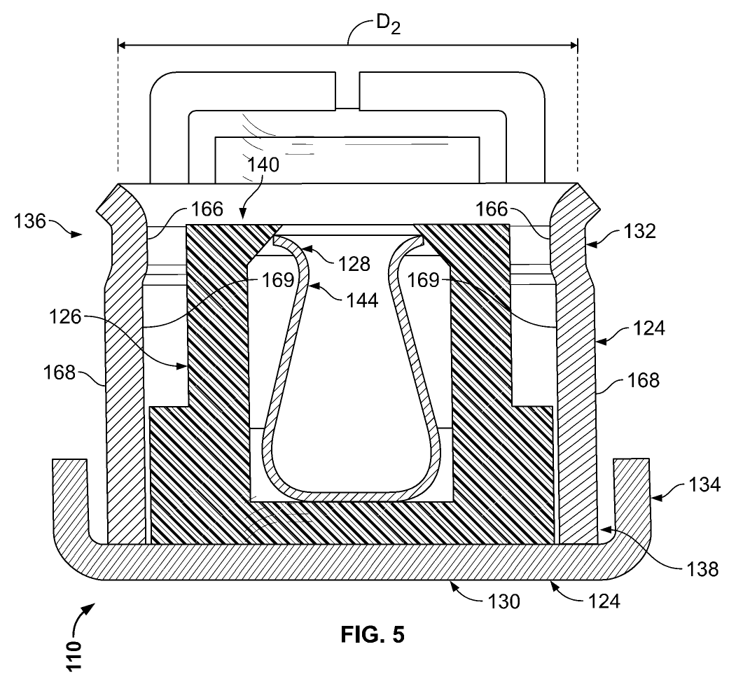

The UMCC 10 includes an electrically conductive housing 24, an insulating member 26 held by the housing 24, and an inner electrical contact 28 held by the insulating member 26. In the exemplary embodiment, the inner electrical contact 28 is a plug contact, which is sometimes referred to as a “pin contact”. Alternatively, the inner electrical contact 28 is a receptacle contact (such as, but not limited to, the receptacle contact 128 shown in FIGS. 4 and 5). The housing 24 includes a body 30 having an outer electrical contact 32 and a base 34. The outer electrical contact 32 is coaxial with the inner electrical contact 28 and is positioned radially outward from the inner electrical contact 28. The outer electrical contact 32 extends between a pair of opposite end portions 36 and 38 and defines a receptacle 40. As will be described in more detail below, in the exemplary embodiment the outer electrical contact 32 of the UMCC 10 includes an outer diameter D₁ in the range of between approximately one and approximately four millimeters. In the exemplary embodiment, the housing 24, and therefore the outer electrical contact 32, is a ground path, while the inner electrical contact 28 is a signal path. Alternatively, the housing 24, and therefore the outer electrical contact 32, is a signal path and the inner electrical contact 28 is a ground path.

A portion 42 of the insulating member 26 of the UMCC 10 is held within the receptacle 40 of the outer electrical contact 32. The insulating member 26 holds a plug contact portion 44 of the inner electrical contact 28 within the receptacle 40 and electrically isolates the inner electrical contact 28 from the outer electrical contact 32 of the housing 24 as well as portions of the base 34. As will be described in more detail below, the inner electrical contact 28 is engaged with, and thereby electrically connected to, the inner electrical conductor 16 of the coaxial cable 14. The plug contact portion 44 of the inner electrical contact 28 extends between a pair of opposite end portions 41 and 43 and is configured to be received by a receptacle contact portion (such as, but not limited to, the receptacle contact portion 144 shown in FIGS. 4 and 5) of another UMCC (such as, but not limited to, the UMCC 110 shown in FIGS. 4 and 5) that is configured to mate with the UMCC 10. Similarly, the outer electrical contact 32 is configured to engage an outer electrical contact (such as, but not limited to, the outer electrical contact 132 shown in FIGS. 4 and 5) of the other UMCC. In some embodiments, the other UMCC is mounted on a substrate, such as, but not limited to, a circuit board, a panel, and/or the like. In other embodiments, the other UMCC terminates the end of another coaxial cable (such as, but not limited to, the coaxial cable 114 shown in FIGS. 4 and 5). As will be described in more detail below, the outer electrical contact 32 is electrically connected to the outer electrical conductor 20 of the coaxial cable 14 via engagement between the outer electrical conductor 20 and the housing base 34.

The housing 24 extends a length L along a central longitudinal axis 45 between a mating end portion 46 and a cable-receiving end portion 48. The cable-receiving end portion 48 engages the insulating cover 22 of the coaxial cable 14, while the mating end portion 46 engages the other UMCC. In the exemplary embodiment, the outer electrical contact 32 is located at the mating end portion 46 of the housing 24. The base 34 extends the length L along the central longitudinal axis 45 between the mating end portion 46 and the cable-receiving end portion 48. When the UMCC 10 assembled as shown in FIGS. 1-3, 6, and 7, the base 34, at the mating end portion 46, covers, or closes, the end portion 38 (which is initially open) of the outer electrical contact 32 and the base 34 extends outwardly from the outer electrical contact 32 along the coaxial cable 14.

The base 34 of the housing 24 includes a pair of opposite cover tabs 50, a pair of opposite ground tabs 52, and a pair of opposite retention tabs 54. The insulating member 26 includes an extension 56 that extends outwardly from the portion 42 of the insulating member 26 and is received within an extension 58 of the outer electrical contact 32 of the housing 24. When the UMCC 10 is assembled as shown in FIGS. 1-3, the extensions 56 and 58 extend outwardly from the insulating member portion 42 and the outer electrical contact 32, respectively, along the base 34 toward the cable-receiving end portion 48 of the base 34. Although only one extension 56 and only one extension 58 is shown, the insulating member 26 and the outer electrical contact 32 may each have any number of extensions 56 and 58, respectively.

The cover tabs 50 extend outwardly from opposite side portions of the base 34. When the UMCC 10 is assembled as shown in FIGS. 1-3, free end portions of the cover tabs 50 oppose one another, the coaxial cable end 12 engages the base 34 of the housing 24, and the cover tabs 50 are wrapped around a portion of the insulating cover 22. The cover tabs 50 are crimped such that the cover tabs 50 engage the insulating cover 22 to facilitate securing the coaxial cable 14 to the UMCC 10, as shown in FIGS. 1-3. In an alternative embodiment, the base 34 may include only one cover tab (not shown) that extends from either of the opposite side portions of the base 34 to an end portion that opposes the other side portion. Moreover, the base 34 may alternatively include a continuous cover tab (not shown) that extends from both of the opposite side portions of the base 34. Although one cover tab 50 is shown extending from each of the opposite side portions of the base 34, each of the opposite side portions of the base 34 may include any number of cover tabs 50 extending therefrom.

The retention tabs 54 extend outwardly from opposite side portions of the base 34. When the UMCC 10 is assembled as shown in FIGS. 1-3, free end portions of the retention tabs 54 oppose one another and the retention tabs 54 are wrapped around a portion of the extension 58 of the outer electrical contact 32. The retention tabs 54 are crimped such that the retention tabs 54 engage the extension 58 and hold the extension 58 between a portion of the retention tabs 54 and a portion of the base 34. The retention tabs 54 facilitate retaining the outer electrical contact 32 in the position with respect to the base 34 that is shown in FIGS. 1-3. In an alternative embodiment, the base 34 may include only one retention tab (not shown) that extends from either of the opposite side portions of the base 34 to an end portion that opposes the other side portion. Although one retention tab 54 is shown extending from each of the opposite side portions of the base 34, each of the opposite side portions of the base 34 may include any number of retention tabs 54 extending therefrom.

As shown in FIG. 3, at the end 12 of the coaxial cable 14, the outer electrical conductor 20 is exposed from the insulating cover 22, the insulating member 18 is exposed from the outer electrical conductor 20, and the inner electrical conductor 16 is exposed from the insulating member 18. Referring again to FIGS. 1-3, the ground tabs 52 extend outwardly from opposite side portions of the base 34. When the UMCC 10 is assembled as shown in FIGS. 1-3, free end portions of the ground tabs 52 oppose one another and the ground tabs 52 are wrapped around a portion of the exposed portion of the outer electrical conductor 20 of the coaxial cable 14. The ground tabs 52 are crimped such that the ground tabs 52 engage the exposed portion of the outer electrical conductor 20 of the coaxial cable 14 to electrically connect the outer electrical conductor 20 to the housing 24, and therefore to the outer electrical contact 32 of the housing 24. Engagement between a portion of the base 34 and the exposed portion of the outer electrical conductor 20 of the coaxial cable 14 also electrically connects the outer electrical conductor 20 to the housing 24, and therefore to the outer electrical contact 32 of the housing 24.

In an alternative embodiment, the base 34 may include only one ground tab (not shown) that extends from either of the opposite side portions of the base 34 to an end portion that opposes the other side portion. Moreover, the base 34 may alternatively include a continuous ground tab (not shown) that extends from both of the opposite side portions of the base 34. Although one ground tab 52 is shown extending from each of the opposite side portions of the base 34, each of the opposite side portions of the base 34 may include any number of ground tabs 52 extending therefrom.

As can be seen in FIG. 3, the extension 56 of the insulating member 26 holds a portion of the inner electrical contact 28 within an opening 60 of the insulating member 26 and electrically isolates the inner electrical contact 28 from the base 34 and the outer electrical contact 32 of the housing 24. The inner electrical contact 28 engages the exposed portion of the inner electrical conductor 16 to electrically connect the inner electrical contact 28 of the UMCC 10 with the inner electrical conductor 16 of the coaxial cable 14. The inner electrical contact 28 may have any suitable size, shape, geometry, and/or the like, and may engage the exposed portion of the inner electrical conductor 16 in any suitable configuration, arrangement, using any suitable structure and/or means, and/or the like. In the exemplary, the inner electrical contact 28 includes a pair of extensions 62 and 64 that extend from the plug contact portion 44 toward the cable-receiving end portion 48. The exposed portion of the inner electrical conductor 16 is clamped between the extensions 62 and 64 to electrically connect the inner electrical conductor 16 to the inner electrical contact 28. Although the extension 64 is shown as extending from the plug contact portion 44, the extension 64 may alternatively extend from the extension 62, such as, but not limited to, adjacent the free end portion of the extension 62. In an exemplary alternative embodiment, the inner electrical contact 28 includes an opening (not shown) within the plug contact portion 44 that receives the exposed portion of the inner electrical conductor 16 such that the inner electrical conductor 16 engages, and is thereby electrically connected to, the inner electrical contact 28.

Referring now to FIGS. 1 and 2, the outer electrical contact 32 of the housing 24 may optionally include a groove 66 extending within a radially outer surface 68 of the outer electrical contact 32 that cooperates with an extension (e.g., the extension 166 shown in FIG. 4) of another UMCC (such as, but not limited to, the UMCC 110) that is configured to mate with the UMCC 10. Cooperation between the groove 66 and the extension creates a snap-fit connection that may facilitate holding the two UMCCs together. Additionally or alternatively, the outer electrical contact 32 of the housing 24 may optionally include an extension (not shown) extending outwardly from the radially outer surface 68 that cooperates with a groove (not shown) of UMCC that is configured to mate with the UMCC 10. Moreover, the outer electrical contact 32 of the housing 24 may alternatively include a groove (not shown) or an extension (not shown) extending on a radially inner surface 69 of the outer electrical contact 32 that cooperates with a respective extension or groove of another UMCC that is configured to mate with the UMCC 10.

Although the UMCC 10 is described and illustrated herein as including a plug contact 28, the UMCC 10 may alternatively include a receptacle contact. FIG. 4 is a perspective view of another exemplary embodiment of a UMCC 110 illustrating the UMCC 110 terminating the end 112 of a coaxial cable 114. FIG. 5 is a cross-sectional view of the UMCC 110 and coaxial cable 114 taken along line 5-5 of FIG. 4. The UMCC 110 includes an electrically conductive housing 124, an insulating member 126 held by the housing 124, and an inner electrical contact 128 held by the insulating member 126. In contrast to the plug contact portion 44 (FIGS. 1-3 and 7) of the inner electrical contact 28 (FIGS. 1-3 and 7), the inner electrical contact 128 is a receptacle contact that includes a receptacle contact portion 144. Alternatively, the inner electrical contact 128 is a plug contact (such as, but not limited to, the plug contact 28 shown in FIGS. 1-3 and 7).

The housing 124 includes a body 130 having an outer electrical contact 132 and a base 134. The outer electrical contact 132 extends between a pair of opposite end portions 136 and 138 and defines a receptacle 140. As will be described in more detail below, in the exemplary embodiment the outer electrical contact 132 of the UMCC 110 includes an inner diameter D₂ in the range of approximately one millimeter and approximately four millimeters. In the exemplary embodiment, the housing 124, and therefore the outer electrical contact 132, is a ground path, while the inner electrical contact 128 is a signal path. Alternatively, the housing 124, and therefore the outer electrical contact 132, is a signal path and the inner electrical contact 128 is a ground path.

The insulating member 126 holds the receptacle contact portion 144 of the inner electrical contact 28 within the receptacle 140 and electrically isolates the inner electrical contact 128 from the outer electrical contact 132 of the housing 124 as well as portions of the base 134. The receptacle contact portion 144 of the inner electrical contact 128 is configured to receive a plug contact (such as, but not limited to, the plug contact portion 44 shown in FIGS. 1-3 and 7) of another UMCC (such as, but not limited to, the UMCC 10 shown in FIGS. 1-3, 6, and 7) that is configured to mate with the UMCC 110. Similarly, the outer electrical contact 132 is configured to engage an outer electrical contact (such as, but not limited to, the outer electrical contact 32 shown in FIGS. 1-3 and 7) of the other UMCC. In some embodiments, the other UMCC is mounted on a substrate, such as, but not limited to, a circuit board, a panel, and/or the like. In other embodiments, the other UMCC terminates the end of another coaxial cable (such as, but not limited to, the coaxial cable 14 shown in FIGS. 1-3, 6, and 7).

The housing 124 is electrically connected to an outer electrical conductor (not shown) of the coaxial cable 114, while the inner electrical contact 128 is electrically connected to an inner electrical conductor (not shown) of the coaxial cable 14. In the exemplary embodiment, the inner electrical conductor of the coaxial cable 114 is a signal path while the outer electrical conductor of the coaxial cable 114 is a ground path. However, alternatively the inner electrical conductor of the coaxial cable 114 may be a ground path while the outer electrical conductor of the coaxial cable is a signal path.

The outer electrical contact 132 of the housing 124 may optionally include an extension 166 extending outwardly from a radially inner surface 169 of the outer electrical contact 132 that cooperates with a groove (e.g., the groove 66 shown in FIGS. 1 and 2) of another UMCC (such as, but not limited to, the UMCC 10 shown in FIGS. 1-3, 6, and 7) that is configured to mate with the UMCC 110. Cooperation between the extension 166 and the groove creates a snap-fit connection that may facilitate holding the two UMCCs together. Additionally or alternatively, the outer electrical contact 132 of the housing 124 may optionally include a groove (not shown) extending within the radially inner surface 169 that cooperates with an extension (not shown) of another UMCC that is configured to mate with the UMCC 110. Moreover, the outer electrical contact 132 of the housing 124 may alternatively include a groove (not shown) or an extension (not shown) extending on a radially outer surface 168 of the outer electrical contact 132 that cooperates with a respective extension or groove of another UMCC that is configured to mate with the UMCC 110.

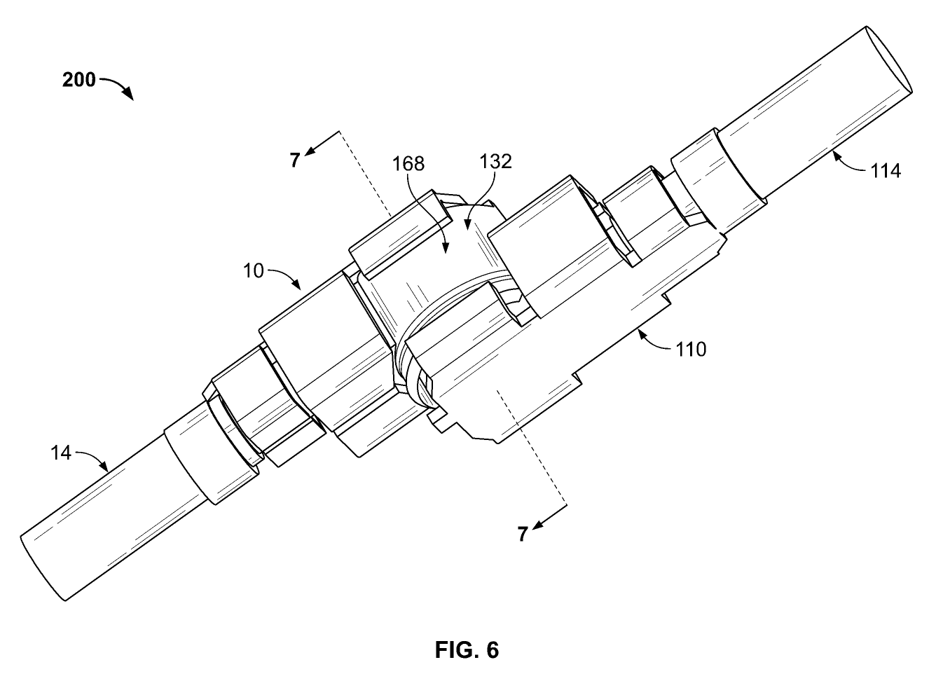

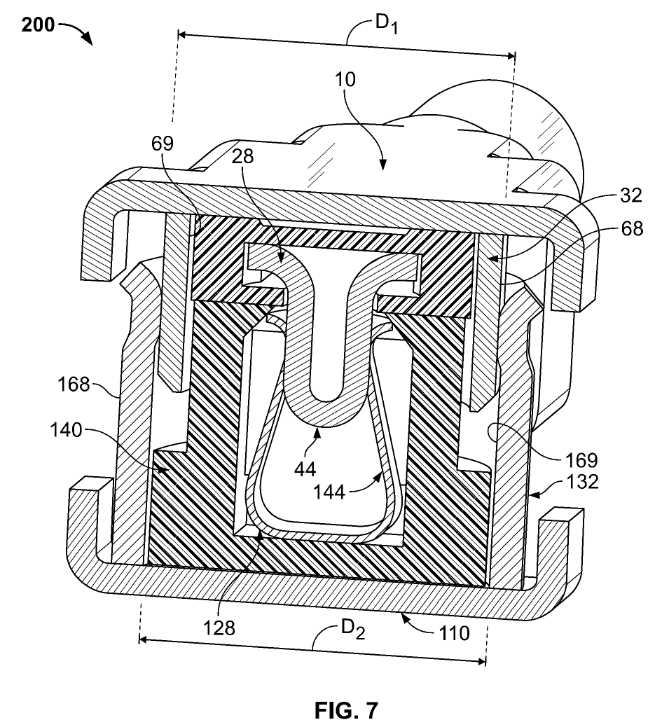

FIG. 6 is a perspective view of an exemplary embodiment of a UMCC assembly 200 illustrating the UMCC 10 mated together with the UMCC 110. FIG. 7 is a partially broken-away perspective view illustrating a cross section of the UMCC assembly 200 taken along line 7-7 of FIG. 6. When the UMCCs 10 and 110 are mated together as shown in FIGS. 6 and 7, the radially outer surface 68 of the outer electrical contact 32 of the UMCC 10 engages the radially inner surface 169 of the outer electrical contact 132 of the UMCC 110 such that the outer electrical contact 32 defines a plug that is received within the receptacle 140 defined by the outer electrical contact 132. Alternatively, the UMCCs 10 and 110 are configured such that the radially outer surface 168 of the outer electrical contact 132 of the UMCC 110 engages the radially inner surface 69 of the outer electrical contact 32 of the UMCC 10 such that the outer electrical contact 132 defines a plug that is received within the receptacle 40 defined by the outer electrical contact 32.

When the UMCCs 10 and 110 are mated together as shown in FIGS. 6 and 7, the plug contact portion 44 of the inner electrical contact 28 of the UMCC 10 engages, and is therefore electrically connected to, the receptacle contact portion 144 of the inner electrical contact 128 of the UMCC 110. Accordingly, the inner electrical conductor 16 (FIG. 3) of the coaxial cable 14 is electrically connected to the inner electrical conductor of the coaxial cable 114. Similarly, the outer electrical conductor 20 (FIG. 3) of the coaxial cable 14 is electrically connected to the outer electrical conductor 120 of the coaxial cable 114 via the engagement between the outer electrical contacts 32 and 132 described above.

The outer electrical contact 32 of the UMCC 10 and the outer electrical contact 132 of the UMCC 110 include respective outer and inner diameters D₁ and D₂ that are similar, such that the outer electrical contact 32 can be received within the receptacle 140 of the outer electrical contact 132. In the exemplary embodiment, the outer electrical contact 32 of the UMCC 10 includes an outer diameter D₁ (also shown in FIG. 3) in the range of approximately one millimeter and approximately four millimeters. Similarly, in the exemplary embodiment the outer electrical contact 132 of the UMCC 110 includes an inner diameter D₂ (also shown in FIG. 5) in the range of approximately one millimeter to approximately four millimeters. As used herein, the term “approximately” includes any tolerances included within the diameters D₁ and/or D₂ to enable mating between the UMCCs 10 and 110. In the alternative embodiment wherein the UMCCs 10 and 110 are configured such that the radially outer surface 168 of the outer electrical contact 132 of the UMCC 110 defines a plug that is received within the receptacle 40 defined by the outer electrical contact 32, an inner diameter of the outer electrical contact 32 of the UMCC 10 is sized similar to an outer diameter of the outer electrical contact 132 of the UMCC 110.

The embodiments described and/or illustrated herein provide a pair of coaxial cables that may be interconnected via a pair of UMCCs.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

While the subject matter described and/or illustrated herein has been described in terms of various specific embodiments, those skilled in the art will recognize that the subject matter described and/or illustrated herein can be practiced with modification within the spirit and scope of the claims.

What is claimed is:

1. An ultraminiature coax connector (UMCC) for terminating a coaxial cable, said UMCC comprising:
an electrically conductive housing extending between a cable-receiving end portion and a mating end portion, the cable-receiving end portion being configured to engage an insulating cover of the coaxial cable, the mating end portion being configured to engage another UMCC, the housing comprising an outer electrical contact at the mating end portion, wherein the outer electrical contact comprises an outer diameter in the range of approximately one millimeter to approximately four millimeters or an inner diameter in the range of approximately one millimeter to approximately four millimeters;
an insulating member held by the housing; and
an inner electrical contact held by the insulating member, the inner electrical contact comprising a plug contact portion that is configured to be received by a receptacle contact portion of the other UMCC.

2. The UMCC according to claim 1, wherein the outer electrical contact is a first outer electrical contact and comprises the outer diameter in the range of approximately one millimeter to approximately four millimeters and a radially outer surface that is configured to engage a radially inner surface of a second outer electrical contact of the other UMCC.

3. The UMCC according to claim 1, wherein the outer electrical contact is a first outer electrical contact and comprises the inner diameter in the range of approximately one millimeter to approximately four millimeters and a radially inner surface that is configured to engage a radially outer surface of a second outer electrical contact of the other UMCC.

4. The UMCC according to claim 1, further comprising the coaxial cable.

5. The UMCC according to claim 1, further comprising the coaxial cable, wherein the cable-receiving end portion is engaged with the insulating cover of the coaxial cable, the outer electrical contact is electrically connected to an outer electrical conductor of the coaxial cable, and the inner electrical contact is electrically connected to an inner electrical conductor of the coaxial cable.

6. An ultraminiature coax connector (UMCC) assembly comprising:
a first UMCC terminating a first coaxial cable, said first UMCC comprising:
a first electrically conductive housing comprising a first outer electrical contact, the first outer electrical contact comprising a first outer diameter in the range of approximately one millimeter to approximately four millimeters or a first inner diameter in the range of approximately one millimeter to approximately four millimeters;
a first insulating member held by the first housing; and
a first inner electrical contact held by the first insulating member; and
a second UMCC terminating a second coaxial cable, said second UMCC comprising:
a second electrically conductive housing comprising a second outer electrical contact engaged with the first outer electrical contact of the first UMCC, the second outer electrical contact comprising a second outer diameter in the range of approximately one millimeter to approximately four millimeters or a second inner diameter in the range of approximately one millimeter to approximately four millimeters;
a second insulating member held by the second housing; and
a second inner electrical contact held by the second insulating member and engaged with the first inner electrical contact of the first 1UMCC.

7. The UMCC assembly according to claim 6, wherein the first outer electrical contact comprises the first outer diameter in the range of approximately one millimeter to approximately four millimeters and a radially outer surface that is engaged with a radially inner surface of the second outer electrical contact of the second UMCC.

8. The UMCC assembly according to claim 6, wherein the first outer electrical contact comprises the first inner diameter in the range of approximately one millimeter to approximately four millimeters and a radially inner surface that is engaged with a radially outer surface of the second outer electrical contact of the second UMCC.

9. The UMCC assembly according to claim 6, wherein the second outer electrical contact comprises the second outer diameter in the range of approximately one millimeter to approximately four millimeters and a radially outer surface that is engaged with a radially inner surface of the first outer electrical contact of the first UMCC.

10. The UMCC assembly according to claim 6, wherein the second outer electrical contact comprises the second inner diameter in the range of approximately one millimeter to approximately four millimeters and a radially inner surface that is engaged with a radially outer surface of the first outer electrical contact of the first UMCC.

11. The UMCC assembly according to claim 6, wherein the first inner electrical contact comprising a plug contact portion, and the second inner electrical contact comprises a receptacle contact portion having the plug contact portion of the first inner electrical contact received therein

12. An ultraminiature coax connector (UMCC) assembly comprising:
a first UMCC configured to terminate a first coaxial cable, said first UMCC comprising a first electrically conductive housing comprising a first outer electrical contact, the first outer electrical contact comprising a first outer diameter in the range of approximately one millimeter to approximately four millimeters or a first inner diameter in the range of approximately one millimeter to approximately four millimeters; and
a second UMCC configured to terminate a second coaxial cable, said second UMCC comprising a second electrically conductive housing comprising a second outer electrical contact, the second outer electrical contact comprising a second outer diameter in the range of approximately one millimeter to approximately four millimeters or a second inner diameter in the range of approximately one millimeter to approximately four millimeters, wherein the first and second UMCCs are configured to be mated together to interconnect the first and second coaxial cables.

13. The UMCC assembly according to claim 12, wherein the first and second outer electrical contacts are configured to be engaged together when the first and second UMCCs are mated together.

14. The UMCC assembly according to claim 12, wherein the first and second UMCCs comprise first and second inner electrical contacts that are configured to be engaged together when the first and second UMCCs are mated together.

15. The UMCC assembly according to claim 12, wherein the first and second UMCCs comprise first and second inner electrical contacts, the first inner electrical contact comprising a plug contact portion, the second inner electrical contact comprising a receptacle contact portion configured to receive the plug contact portion of the first inner electrical contact therein when the first and second UMCCs are mated together.

16. The UMCC assembly according to claim 12, wherein the first outer electrical contact comprises the first outer diameter in the range of approximately one millimeter to approximately four millimeters and a radially outer surface that is engaged with a radially inner surface of the second outer electrical contact of the second UMCC.

17. The UMCC assembly according to claim 12, wherein the first outer electrical contact comprises the first inner diameter in the range of approximately one millimeter to approximately four millimeters and a radially inner surface that is engaged with a radially outer surface of the second outer electrical contact of the second UMCC.

18. The UMCC assembly according to claim 12, wherein the second outer electrical contact comprises the second outer diameter in the range of approximately one millimeter to approximately four millimeters and a radially outer surface that is engaged with a radially inner surface of the first outer electrical contact of the first UMCC.

19. The UMCC assembly according to claim 12, wherein the second outer electrical contact comprises the second inner diameter in the range of approximately one millimeter to approximately four millimeters and a radially inner surface that is engaged with a radially outer surface of the first outer electrical contact of the first UMCC.
